(19) United States
(12) Patent Application Publication
(10) Pub. No.: US 2019/0234771 A1
(43) Pub. Date: Aug. 1, 2019

(54) OPTICAL MODULE

(71) Applicant: SHENZHEN DARMA TECHNOLOGY CO., LTD., Shenzhen City, Guangdong Province (CN)

(72) Inventors: CHAO YANG, Shenzhen City, Guangdong Province (CN); JUNHAO HU, Shenzhen City, Guangdong Province (CN)

(21) Appl. No.: 16/091,974

(22) PCT Filed: Feb. 14, 2017
(86) PCT No.: PCT/CN2017/073527

§ 371 Date: Apr. 19, 2019

(30) Foreign Application Priority Data
Apr. 6, 2016 (CN) 201620280223.2

(51) Int. Cl. G01D 5/26

(52) U.S. Cl. CPC G01D 5/268

(57) ABSTRACT

An optical module applied to a fiber optic sensor. The optical module comprises a housing (11), a circuit board (12) installed in the housing (11) and a digital-to-analog conversion circuit (121), a light source control circuit (122) and an electro-optic conversion unit (123) installed on the circuit board (12) and sequentially and electrically connected. Also installed on the circuit board (12) and sequentially and electrically connected are an opto-electronic conversion unit (124), a signal filter amplification circuit (125) and an analog-to-digital conversion circuit (126), and a circuit interface (127) installed on the circuit board (12) is separately and electrically connected to the digital-to-analog conversion circuit (121) and the analog-to-digital conversion circuit (126) respectively. The optical module enables control of a fiber optic sensor and modularization of acquisition circuits, thus providing an application system for a fiber optic sensor with a simple and low-cost structure.

### TECHNICAL FIELD

The present invention relates to an optical fiber sensor, and especially to an optical module applied to the fiber optic sensor.

### BACKGROUND

The optical fiber sensor as a new type of sensor, has super detection accuracy and sensitivity, as well as low cost, highly anti-interference, portability and expansibility, so that it's more and more widely used for temperature and pressure measurement. For example, the optical fiber sensor can convert weak vibration signals (such as mechanical shock signals from breathing and heartbeat) into light signals so as to detect physiological signals such as respiration signals and/or heartbeat signals. Further, the optical fiber sensor can also detect optical signal change from pressure change on a surface of the detection sensor, such as change of optical intensity, wavelength, modulation frequency, or phase, and so as to be used to determine a posture of the user. However, control and acquisition circuits of the existing optical fiber sensor are not modularized, which cause a complicate structure and high cost of the optical fiber sensor, and accordingly cause complicate structure and high cost of the application system with the optical fiber sensor.

### Technical Problems

An object of the present invention is to provide an optical module, to solve the problem of the previous optical fiber sensor of which the control and acquisition circuits are not modularized, and that the structure of the optical fiber sensor and the application system with the optical fiber sensor are complicated and the cost is high.

### Technical Solution

An optical module of the present invention is applied to an optical fiber sensor. The optical module comprises: a housing; a circuit board installed in the housing; a digital-to-analog conversion circuit, a light source control circuit and an electro-optic conversion unit installed on the circuit board and electrically connected sequentially; an opto-electronic conversion unit, a signal filter amplification circuit and an analog-to-digital conversion circuit installed on the circuit board and electrically connected sequentially; and a circuit interface installed on the circuit board which is electrically connected to the digital-to-analog conversion circuit and the analog-to-digital conversion circuit respectively.

Further, the circuit board is a piece of rigid circuit board.

Further, the circuit board comprises an optical flexible circuit board and a signal processing circuit board, both the electro-optic conversion unit and the opto-electronic conversion unit are installed on the optical flexible circuit board, while the digital-to-analog conversion circuit, the light source control circuit, the signal filter amplification circuit and the analog-to-digital conversion circuit are installed on the signal processing circuit board.

Further, the optical flexible circuit board is installed on the signal processing circuit board via an FPC or by soldering.

Further, the optical module is an SFP optical module, a GBIC optical module, an XFP optical module, an SFF optical module, an XPAK optical module or an SFP+ optical module.

Further, the housing comprises a housing body and an unlock structure installed on the housing body.

Further, the housing body is made of metal.

### Advantages of the Invention

In the present invention, the digital-to-analog conversion circuit, the light source control circuit, the electro-optic conversion unit, the opto-electronic conversion unit, the signal filter amplification circuit, and the analog-to-digital conversion circuit of the optical fiber sensor are all installed on the circuit board, and the circuit board is installed in the housing. Therefore, the modularization of the control and acquisition circuits of the optical fiber sensor is realized; so that the structure of optical fiber sensor is simple and the cost is low, and accordingly the application system with optical fiber sensor is simple in structure and low in cost. Moreover, because the housing body is made of metal material, it has shielding effect, and can improve the anti-interference ability of the analogous circuit when it is used in the sensor.

### BRIEF DESCRIPTION OF THE DRAWINGS

FIG. 1 illustrates a schematic diagram of an optical module in accordance with an embodiment of the present invention.

### DETAILED DESCRIPTION

The objects, features and advantages of the invention will become more apparent from the following detailed description of the embodiments thereof when taken in conjunction with the accompanying drawings. It is understood that, the detailed description of the embodiments given below, serve to explain the principles of the invention, but is not intended to limit the present invention to these embodiments.

The following description of certain embodiments is used to illustrate the features of the present invention.

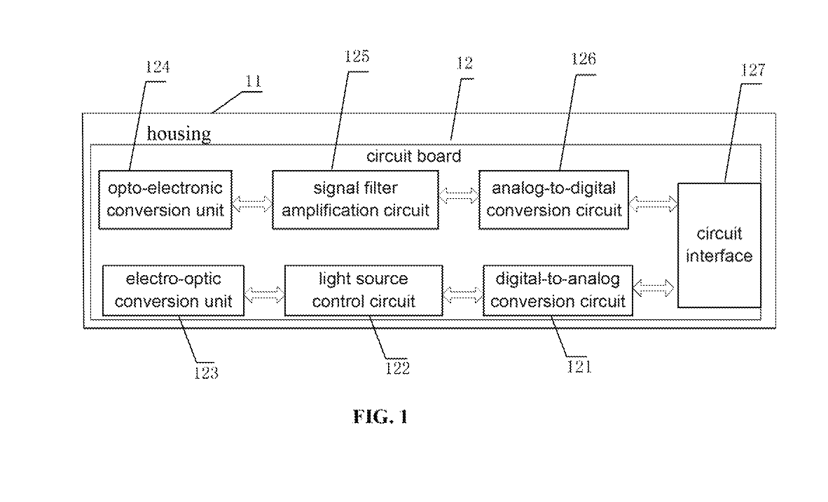

Referring to FIG. 1, an optical module provided in accordance with the embodiment of the present invention, is applied to an optical fiber sensor. The optical module comprises: a housing 11; a circuit board 12 installed in the housing 11; a digital-to-analog conversion circuit 121, a light source control circuit 122, and an electro-optic conversion unit 123 which are all installed on the circuit board 12 and electrically connected sequentially; an opto-electronic conversion unit 124, a signal filter amplification circuit 125 and an analog-to-digital conversion circuit 126 which are all installed on the circuit board 12 and electrically connected sequentially; and a circuit interface 127 installed on the circuit board 12 which is electrically connected to the digital-to-analog conversion circuit 121 and the analog-to-digital conversion circuit 126 respectively.

The circuit board 12 in accordance with the embodiment of the present invention, can be a piece of rigid circuit board, and can comprise an optical flexible circuit board and a signal processing circuit board. Herein, both the electro-optic conversion unit 123 and the opto-electronic conversion unit 124 are installed on the optical flexible circuit board; while the digital-to-analog conversion circuit 121, the light source control circuit 122, the signal filter amplification circuit 125 and the analog-to-digital conversion circuit 126 are all installed on the signal processing circuit board. The structure design of the optical module can become simpler and more flexible via installing the electro-optic conversion unit 123 and the opto-electronic conversion unit 124 on the optical flexible circuit board. The optical flexible circuit board can be installed on the signal processing circuit board by FPC or by soldering.

The optical module in accordance with the embodiment of the present invention, may be an SFP (Small Form-factor Pluggable, SFP) optical module, the SFP optical module meets Multi-Source Agreements (MSA), and has advantages of unified interface standard, small size and low power consumption; and the interface connectors and equipments coupled to the SFP optical module are also very universal. Certainly, the optical module in accordance with the embodiment of the present invention may also be a GBIC optical module, an XFP optical module, an SFF optical module, an XPAK optical module, or an SFP+ optical module.

The circuit interface 127 is used as an external circuit interface of the whole optical module, it can supply electricity to the optical module by connecting with the external equipment through this circuit interface, Digital control signals input from the circuit interface are converted to analog signals by the analog-to-digital conversion circuit 126, and then are used to control optical signal intensity of the electro-optic conversion unit 123 by the light source control circuit 122, Optical signals through the optical fiber sensor are converted to electric signals by the opto-electronic conversion unit 124, and then are amplified and filtered by the signal filter amplification circuit 125, then the analog electric signals are converted to digital signals by the analog-to-digital conversion circuit 126, and are output from the circuit interface 127, The output digital signals indicate the intensity of the received optical signals. Based on this principle, the optical module in accordance with the embodiment of the present invention can be applied to a measurement system of the optical fiber sensor.

The circuit interface 127 in accordance with the embodiment of the present invention may be a common standard interface, so it can be easily integrated into other systems.

The housing 11 of the optical module in accordance with the embodiment of the present invention comprises a housing body and an unlock structure fixed on the housing body. The unlock structure facilitates the optical module to plug. The housing body can be made from metal material, so that the housing possesses shielding effect, and can improve the anti-interference ability of the analog circuit when it is used in sensor field.

In accordance with the embodiment of the present invention, the digital-to-analog conversion circuit, the light source control circuit, the electro-optic conversion unit, the opto-electronic conversion unit, the signal filter amplification circuit, and the analog-to-digital conversion circuit of the optical fiber sensor are all installed on the circuit board, and the circuit board is installed in the housing. Therefore, the modularization of the control and acquisition circuits of the optical fiber sensor is realized; so that the structure of optical fiber sensor is simple and the cost is low, and accordingly the application system with optical fiber sensor is simple in structure and low in cost. Moreover, the housing body is made of metal material, and the anti-interference ability of the analog circuit can be improved when it is used in sensor field.

While the above illustrated and described are only preferable embodiments of the present invention but not used to limit the invention. Any modifications, substitutions, and changes etc. without departing from the spirit of the invention should be included within the scope of this invention.

What is claimed is:

1. An optical module, which is characterized that, the optical module is applied to an optical fiber sensor; the optical module comprises: a housing; a circuit board installed in the housing; a digital-to-analog conversion circuit, a light source control circuit and an electro-optic conversion unit which are all installed on the circuit board and electrically connected sequentially; an opto-electronic conversion unit, a signal filter amplification circuit and an analog-to-digital conversion circuit which are all installed on the circuit board and electrically connected sequentially; and a circuit interface installed on the circuit board which is electrically connected to the digital-to-analog conversion circuit and the analog-to-digital conversion circuit respectively.

2. The optical module of claim 1, which is characterized that, the circuit board is a piece of rigid circuit board.

3. The optical module of claim 1, which is characterized that, the circuit board comprises an optical flexible circuit board and a signal processing circuit board, both the electro-optic conversion unit and the opto-electronic conversion unit are installed on the optical flexible circuit board, while the digital-to-analog conversion circuit, the light source control circuit, the signal filter amplification circuit and the analog-to-digital conversion circuit are installed on the signal processing circuit board.

4. The optical module of claim 3, which is characterized that, the optical flexible circuit board is installed on the signal processing circuit board by FPC or by soldering.

5. The optical module of claim 1, which is characterized that, the optical module is an SFP optical module, a GBIC optical module, an XFP optical module, an SFF optical module, an XPAK optical module or an SFP+ optical module.

6. The optical module of claim 1, which is characterized that, the housing comprises a housing body and an unlock structure installed on the housing body.

7. The optical module of claim 6, which is characterized that, the housing body is made of metal.
